(19) United States
(12) Patent Application Publication
(10) Pub. No.: US 2003/0224722 A1
(43) Pub. Date: Dec. 4, 2003

(54) Method of providing network-based wireless extension service

(76) Inventors: Ronald Bruce Martin, Carol Stream, IL (US); Randall Joe Wilson, Naperville, IL (US)

Correspondence Address: Docket Administrator, (Room 3J-219), Lucent Technologies Inc., 101 Crawfords Corner Road, Holmdel, NJ, 07733-3030, US

(21) Appl. No.: 10/159,832

(22) Filed: May 31, 2002

(51) Int. Cl. H04B 7/14

(52) U.S. Cl. 455/11.1; 455/7

(57) ABSTRACT

The present invention provides a method of providing extension service to mobile stations in a wireless communications system. A network call control function receives an incoming call request. Via a query/response sequence with a network user profile data base, the network call control function determines if wireless extension service is enabled and which mobile stations are on the wireless extension list. The network call control function utilizes a network conference bridge to initiate a multiparty call to the mobile stations on the extension list. Inclusion of determination of the geographical location of other mobiles allows call alerting to be restricted to mobiles within a predetermined geographic location.

### CROSS-REFERENCE TO RELATED APPLICATIONS

The present application is related to application Ser. No. ______, entitled “METHOD OF PROVIDING WIRELESS-CONTROLLED WIRELESS EXTENSION SERVICE.” The above patent application is filed on the same day as the present application, assigned to the assignee of the present application, and incorporated by reference herein.

### FIELD OF THE INVENTION

This invention relates generally to the field of wireless communication systems, and more particularly to utilizing wireless phones as extension phones for each other.

### BACKGROUND OF THE INVENTION

Existing analog wireline extensions allow multiple wireline phones to be alerted by an incoming call. In addition, multiple of these wireline extensions can participate in a single call. One limitation to wireline extension phones is that once a phone is engaged in a call, the other phones can participate in the ongoing call but cannot participate in a different call.

In current wireless communication systems, no such extension capability exists. A call destined for a mobile station alerts only that station and only that station can participate in the session.

Therefore, a need exists for a method and apparatus that allows mobile stations to be simultaneously alerted when a call is destined for a member of the group. Further, a need exists for a method that allows multiple wireless phones to be involved in such a call. In addition, a need exists for a method that allows multiple mobile stations to participate in a single call.

### BRIEF SUMMARY OF THE INVENTION

The present invention provides a method for providing extension functionality to multiple mobile stations. A plurality of mobile stations are associated together in an extension group as extension members. When a call is received for a mobile station that is an extension member, all mobile stations in the extension group are alerted. Each user can then decide to accept the call request and join the call or not accept the call request and therefore not join the call. In accordance with the present invention, each mobile station maintains its individuality and can initiate or receive calls without invoking the extension functionality. In an exemplary embodiment of the present invention, via the use of physical location of the mobile stations, only extension members within a certain geographical location are afforded extension functionality.

In accordance with an exemplary embodiment of the present invention, a network-based customer profile database stores a list of identities of the members of the extension group. These identities could be E.164 numbers or any other unique identifier. When a call arrives in the network for a mobile station with extension service enabled, the network engages a conference bridge. The conference bridge initiates a connection to each of the other mobile stations in the extension list. Mobile stations accepting the call are bridged onto the call.

Further, the network can do a location update on the extension members and only bridge the call to other extension members located within a predefined distance of the called mobile station. A unique alerting display is used at the extension mobile stations to indicate that this is an extension call and not a direct call to the extension mobile stations. Extension functionality can be disabled at each mobile station, thereby allowing completely independent operation.

Advantageously, such an arrangement gives mobile station users the functionality of extension phones and allows the mobile stations to also be used in an independent mode.

### BRIEF DESCRIPTION OF THE SEVERAL VIEWS OF THE DRAWINGS

FIG. 1 depicts a communication system in accordance with an exemplary embodiment of the present invention.

FIG. 2 depicts a flow chart of a method for processing a call request in a network call control function in accordance with an exemplary embodiment of the present invention.

FIG. 3 depicts a flow chart of a method for processing a wireless extension query in a user profile data base in accordance with an exemplary embodiment of the present invention.

FIG. 4 depicts a flow chart of a method for processing a call request in the network conference bridging function in accordance with an exemplary embodiment of the present invention.

### DETAILED DESCRIPTION OF THE INVENTION

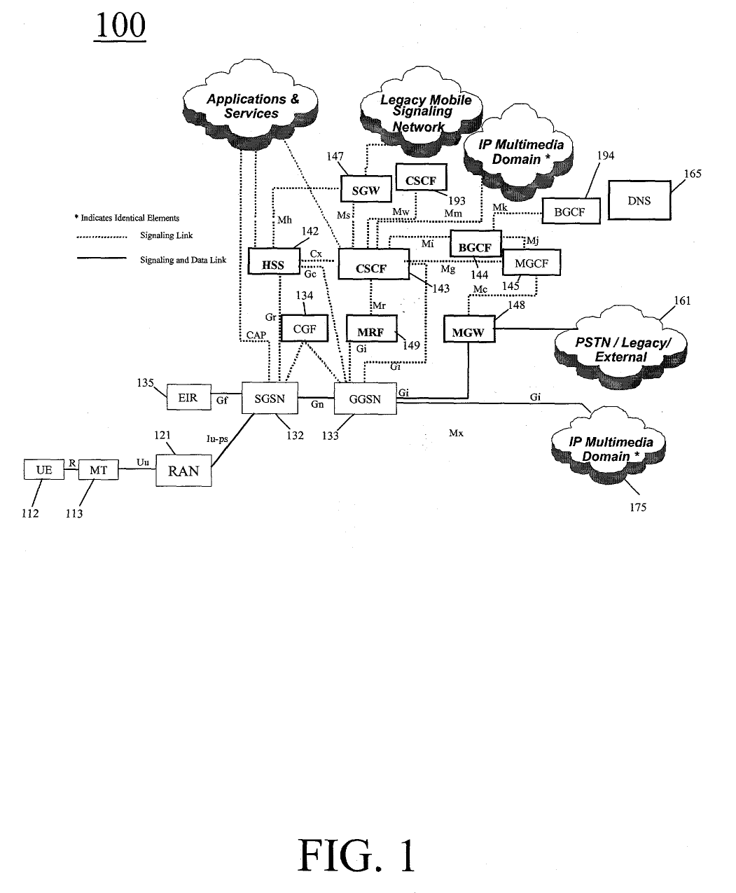

FIG. 1 depicts a communication system 100 in accordance with an exemplary embodiment of the present invention. In the exemplary embodiment depicted in FIG. 1, communication system 100 is a Third Generation (3G) wireless system. Communication system 100 can alternately be any digital cellular system. 3G wireless systems include multiple air interface standards, including cdma2000, Universal Mobile Telecommunications System (UMTS), Wideband CDMA (W-CDMA), Global System for Mobile Communications (GSM), and UWC-136, a TDMA-based technology.

As depicted in FIG. 1, communication system 100 depicts a 3GPP reference architecture of a UMTS wireless network. It should be understood that communication system 100 can alternately be other reference architectures. Communication system 100 includes logical elements that have been defined based on network functions that have been grouped together to form each logical element. Actual implementation may contain multiple copies of these logical elements within multiple networks, and can merge any of these logical elements into single hardware entities. The architecture of the exemplary embodiment of the present invention is designed to utilize emerging Internet standards and protocols. An example of this is the use of Session Initiation Protocol (SIP) for IP Multimedia Subsystem (IMS) signaling for establishing a call. Use of emerging internet-based protocols, such as IPv6, allows for the IMS to provide internet-like functionality and services to mobile units along with voice and data services.

Communication system 100 includes a plurality of logical elements, comprising User Equipment (UE) 112, a Mobile Termination (MT) 113, Radio Access Network (RAN) 121, packet-switched domain 131, IP Multimedia Subsystem (IMS) 141, Charging Gateway Function (CGF) 134, EIR 135, and signaling gateway (SGW) 147.

Both the UMTS-based and GSM/EDGE-based Radio Access Networks are shown in this figure. Charging Gateway Functionality (CGF) 134 is now part of the base 3GPP communication system 100 to show the collection of billing information in packet-switched domain 131. As depicted in FIG. 1, Radio Access Network (RAN) and packet-switched domain 131 are independent of IMS 141.

User equipment can be any device or combination of devices that can be used to connect with a wireless network. User Equipment, for example, can be comprised of User Equipment (UE) 112 and a Mobile Termination (MT) 113. User equipment is preferably a 3G mobile station that communicates with communication system 100 via an air interface supported by communication system 100.

RAN 121 is preferably a UMTS Terrestrial Radio Access Network (UTRAN), which is the primary interface between the wireless device and the UMTS access network. Alternately, RAN 121 can be a GSM/EDGE Radio Access Network (GERAN), which is the primary interface between the wireless device and the GSM/EDGE access network. RAN 121 is coupled to the user equipment via an air interface, such as a 3G air interface.

Packet-switched domain 131 includes Serving GPRS Support Node (SGSN) 132 and GPRS Gateway Support Node (GGSN) 133. SGSN 132 provides packet mobility management, authentication, session management, accounting, mapping of IP addresses to user equipment identification, such as IMSI, maintenance of mobile state information, and interfacing with GGSN 133. GGSN 133 provides interworking between the SGSNs and external packet data networks using IP.

IMS 141 preferably includes Call State Control Function (CSCF) 143, Breakout Gateway Control Function (BGCF) 144, Media Gateway Control Function (MGCF) 145, Media Gateway (MGW) 148, and Multimedia Resource Function (MRF) 149.

CSCF 143 is a signaling entity for bearer/session control. CSCF 143 manages SIP sessions, provides features/services and coordinates with other network elements for session control, feature/service control and resource allocation.

CSCF 143 performs multiple functions, which in an exemplary embodiment include incoming call gateway, call control function, serving profile database, and address handling. In addition, in accordance with an exemplary embodiment of the present invention, CSCF 143 performs the network call control function for wireless extension functionality.

CSCF 143 has interfaces with many network elements, preferably as defined by the Third Generation Partnership Project standards, in standards document 3GPP TS 23.002. CSCF 143 is preferably connected to a plurality of elements using the SIP protocol. These network elements include GGSN 133 via interface Gi, MT 113 using interface Gm (not shown), MGCF 145 using interface Mg, BGCF 144 using interface Mi, MRF 149 using interface Mr, IP Multimedia Domain 175 (not shown), and other CSCFs, such as CSCF 193, using interfaces Mw. CSCF 143 is coupled with HSS 142 via interface Cx, preferably using the DIAMETER protocol. In addition, in accordance with an exemplary embodiment of the present invention, HSS 142 performs the User Profile Data Base function for wireless extension functionality. CSCF 143 is coupled to SGW 147 via interface Ms, which preferably uses a MAP protocol, but can alternately use a CAP or other SS7 application protocol.

BGCF 144 is a signaling entity for bearer/session control. The primary responsibility of BGCF 144 is to select the network to use for inter-working with PSTN 161 for a call from MT 113 to a PSTN address. BGCF 144 preferably performs additional functions, which include but are not limited to selection of the appropriate MGCF, hiding of network information from other networks, and provision of security through authorization of peer network elements.

BGCF 144 communicates with CSCF 143 via Mi interface, with MGCF 145 via Mj interface, and with BGCF 194 via Mk interface. These interfaces are defined in 3GPP TS 23.002. SIP is the preferred protocol for these standard interfaces. BGCF 144 may also have interfaces with other entities (not shown) to assist in making decisions within communication system 100.

BGCF 144 is preferably a logical entity from the 3GPP reference model. The actual implementation of BGCF 144 may be combined on the same platform with other logical entities that perform signaling functions such as CSCF 143, MGCF 145, and SGW 147.

To select a PSTN gateway, BGCF 144 in the home network receives the call origination message, which is an exemplary embodiment is a SIP INVITE message, from CSCF 143. The receipt of a call origination message from CSCF 143 indicates that the destination is a PSTN address. BGCF 144 needs to determine which network should be used to provide inter-working with PSTN 161. BGCF 144 may use data from multiple sources to make this determination. Examples of factors which BGCF 144 may look at in making this determination include, but are not limited to, the current location of the calling UE, the location of the PSTN address, local policies and business agreements between the visited and home networks, the desire to minimize path distance within the PSTN network, and a desire for the least-cost path. If the PSTN gateway is decided to be the home network, an MGCF within the home network, such as MGCF 145, will be selected. If the PSTN gateway is decided to be at another network, the BGCF address for the other network must be determined so that the processing may be forwarded to that network.

BGCF 144 may also provide information hiding functionality. When two BGCFs are used across a network boundary, then the BGCFs may be used to hide local network information from the other network. BGCF 144 can also provide security in communication system 100. BGCF 144 provides security by performing authorization of peer network elements for peer-to-peer SIP application level communication.

MGCF 145 terminates signaling and provides the call control interface and translations between IMS 141 and PSTN 161. MGCF 145 also provides connection control for the media channels in MGW 148. MGCF 145 communicates with MGW 148 via the Mc interface, with BGCF 144 via the Mj interface, and with CSCF 143 via the Mg interface.

MGCF 145 also preferably provides signaling to control a set of Media Gateways (MGW), such as MGW 148. This signaling is preferably in the form of H.248. With H.248, MGCF 145 is able to control establishment of bearer resources for sessions that require inter-working for bearer between PSTN 161 and IMS 141. For calls that require the services of a network operator's MGW, ports are allocated via requests from MGCF 145 within that network operator's network.

Signaling allows MGCF 145 to perform multiple operations with respect to MGW 148. These operations include MGW registration, bearer establishment control between IMS 141 and PSTN 161, request for allocation of media translation resources (i.e., compression, echo cancellation, vocoding, etc.), control of events detected at MGW 148, application of signals such as tones and announcements by MGW 148, and collection of statistics.

MGCF 145 preferably controls multiple MGWs. To be placed into service, the MGWs register themselves with their default MGCF. After registration with an MGCF, MGWs can begin bearer processing.

MGCF 145 preferably implements a SIP-based interface to CSCF 143. BGCF 144 may be in the signaling path between CSCF 143 and MGCF 145. Using this interface, MGCF 145 accepts commands from CSCF 143 to perform functions related to the control of a call.

MGW 148 is the element that translates between a media flow, such as voice, on a given IP network and bearer data on PSTN 161. MGW 148 terminates circuit-switched bearer traffic from PSTN 161 and terminates IP media flow as packet streams through GGSN 133 or MGW 173, eventually reaching the user equipment. MGW 148 preferably performs vocoding and may also provide tones and announcements. If in-band signaling methods are supported at MGW 148, then for PSTN traffic using in-band signaling, MGW 148 preferably terminates both bearer and signaling traffic, and forwards the signaling messages to MGCF 145. MGW 148 interfaces with GGSN 133 via the Gi interface and with MGCF 145 via the Mc interface.

MGW 148 may include resources to modify a bearer stream. These resources allow MGW 148 to perform encoding, compression, echo cancellation, packetization, transcoding, packet timing synchronization, and packet loss handling.

MGW 148 preferably supports multiple types of voice encoding. These include, but are not limited to, G.711, Adaptive Multi-Rate (AMR), and other G.7xx encoding schemes. MGW 148 is preferably able to use G.711 to encode and decode voice on trunks connected to a PSTN network.

MGW 148 preferably organizes bearer connections using H.248 contexts containing terminations. MGW 148 may include numerous simultaneous contexts.

MGW 148 also preferably includes resources to support a plurality of signaling mechanisms, including but not limited to registration with MGCF 145, detection of events (e.g. Dual-Tone Multi-Frequency (DTMF) detection), application of tones and announcements to bearer streams, graceful teardown and random restart, notification, generation of statistics, and support of H.248 packages.

MRF 149 provides packet-based media services, such as advanced announcement generation and detection, N-way conferencing, tone and announcement generation, and future advanced media services, such as video mixing. In addition, in accordance with an exemplary embodiment of the present invention, MRF 149 performs the network conference bridge function for wireless extension functionality. MRF 149 also preferably provides transcoding and interactive voice response. MRF 149 interfaces with CSCF 143 via the Mr interface, with IP Multimedia Domain 175 (not shown), and with GGSN 133 via the Gi interface.

In an exemplary embodiment of the present invention, MRF 149 comprises two parts, a controller part and a bearer part. CSCF 143 preferably interfaces with the MRF controller part to request media services using SIP. The controller part preferably communicates with the bearer part via H.248. The bearer part preferably supports RTP/UDP/IP. Some of the resources maintained by MRF 149 include vocoders, transcoders, compression entities, bearer-stream mixers, echo cancellors, and other DSP resources. Vocoders are needed at MRF 149 for transcoding and mixing of multimedia streams.

HSS 142 provides support for subscriber authentication, subscriber profile management, service authorization, subscriber location management, inter-system handover, and call routing. HSS 142 provides these functions for users receiving service from circuit-switched domain 151, packet-switched domain 131, and IMS 141.

HSS 142 preferably maintains a subscriber database that includes information including, but not limited to, the identity of the subscriber, services and associated policies, location, and authentication data.

HSS 142 supports the following interfaces. Interface Cx is the interface to CSCF 143. The preferred protocol for this interface is DIAMETER. Interface Mh is the interface to SGW 147. Interface Gr is the interface to SGSN 132. Interface Gc is the interface to GGSN 133. Interface C is the interface to GMSC server 153. Interfaces Mh, Gr, Gc, D and C preferably utilize a MAP protocol.

In accordance with an exemplary embodiment of the present invention, HSS 142 recognizes when features and services are to be implemented for a subscriber at either MSC server 152 or IMS 141. In addition, HSS 142 supports procedures for IMS-homed mobile units being served at a remote MSC Server.

SGW 147 terminates transport protocols for signaling between PS domain 113 and IMS 141. The services of SGW 147 are preferably used to ensure transport interworking between the SS7 and the IP transport of signaling on its various interfaces (not all shown). SGW 147 communicates with CSCF 143 and HSS 142 via the Ms and mh interfaces, respectively.

SGW 147 provides for HSS Subscriber roaming into circuit-switched wireless networks and transport of circuit-switched signaling over IP, such as TCP/IP.

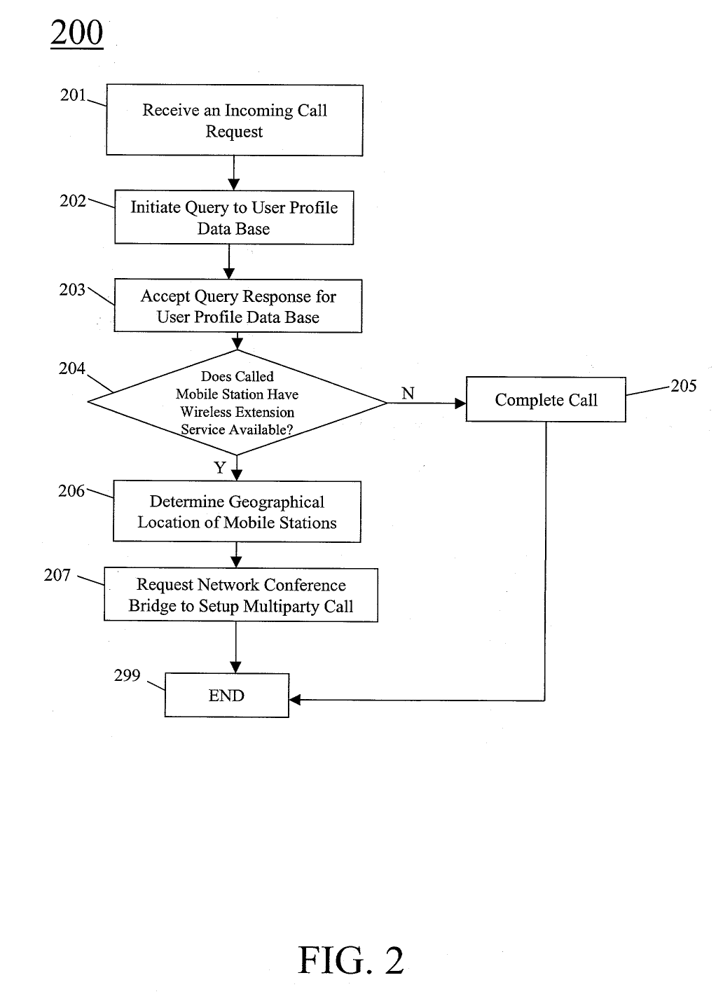

FIG. 2 depicts a flow chart 200 of a method for processing a call request in network call control function 143 in accordance with an exemplary embodiment of the present invention. Network call control function 143 receives (201) an incoming call request. The incoming call request can be for a voice, data, or multimedia call.

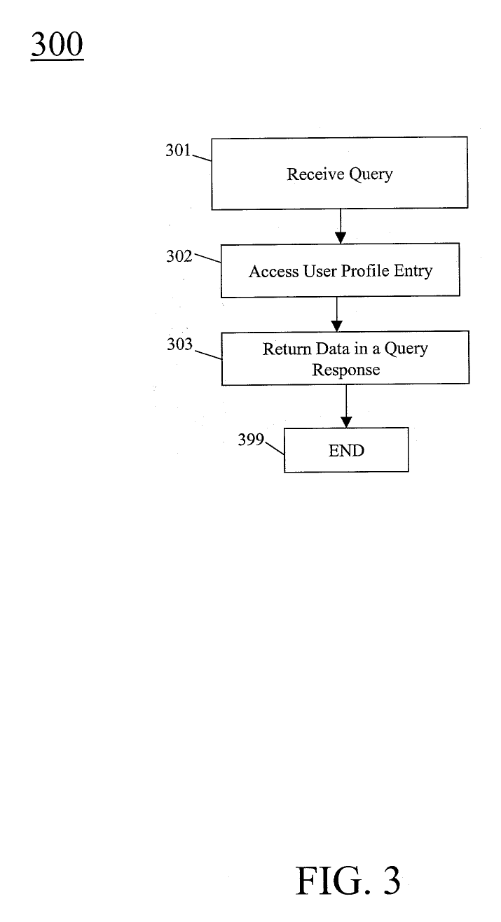

Network call control function 143 initiates (202) a query to user profile data base 142. The query is intended to determine if the called number has the wireless extension functionality enabled. The processing that occurs at user profile database 142 is depicted in FIG. 3.

Turning now to FIG. 3, FIG. 3 depicts a flowchart 300 of a method for processing in user profile data base 142 a wireless extension query in accordance with an exemplary embodiment of the present invention. User profile data base 142 receives (301) the query from network call control function 143. The query preferably includes an indication, such as the directory number, of the called mobile station.

User profile data base 142 accesses (302) a user profile entry associated with the called mobile station. The user profile entry preferably includes a field that indicates whether the wireless extension feature is enabled or disabled and a list of the mobile stations that are members of the extension group. The list can be, for example, a linked list of the directory numbers of all members of the extension group.

User profile data base 142 formulates and returns (303) a query response to network call control function 143. The query response includes selected data from the user profile, preferably whether wireless extension functionality is enabled. If wireless extension functionality is enabled, the query response includes a list including all extension group members. The process then ends (399).

Returning now to FIG. 2, network call control function 143 accepts (203) the query response from user profile data base 142. Network call control function 143 determines (204) if the called mobile station has the wireless extension service enabled. In an exemplary embodiment, network call control function 143 determines if the called mobile station has wireless extension functionality enabled by determining if user profile data base 142 has returned a list that includes at least one other representation of another mobile station. In a further exemplary embodiment, network call control function 143 determines if the called mobile station has wireless extension functionality enabled by checking whether the field indicating whether the wireless extension functionality is enabled or disabled.

If the called mobile station does not have wireless extension service enabled as determined at step 204, network call control function 143 completes (205) the call normally. The processing then ends (299).

In one embodiment of the present invention, wireless extension members will only be alerted to the new call request if they are within a predetermined distance from the called mobile station. In this embodiment, if the called mobile station has wireless extension service enabled as determined at step 204, network call control function 143 determines (206) the geographical location of the mobile stations on the wireless extension list. Network call control function 143 only includes wireless extension members that are located within a predetermined geographical area in the wireless extension service for this call request. The mobile station user can set the geographical area through means currently used to set network options, such as via touch pad entries as used for user screen list editing. The location of the mobile stations on the list can be determined by the network call control function 143 using techniques such as cell and sector, time of arrival, and other similar location-finding techniques. These techniques rely on cooperation of elements such as the Radio Access Network (RAN) 121.

An exemplary embodiment of the present invention includes determination of the locations of the mobile phones in the extension list. Without loss of generality or functionality, the called mobile station can, via existing means, request that the location step be bypassed. An exemplary method of effectively bypassing this step is to set the predetermined geographic region to any area larger than that covered by the communication system, so that all mobile stations in the extension list will be paged.

The following are three representative examples of the use of geographical information used in extension functionality. First, extension service can be offered to mobile stations on a corporate campus. That is, only mobile stations within a predetermined distance from the workplace at a given time would be offered extension service. A second example is when all mobile stations located within a predetermined distance from a residence are offered extension service. In this way personal calls can be shared among mobile stations at the residence without interrupting mobile stations away from the residence. Finally, there can be no geographical limitations at all. All mobiles in the extension list are alerted.

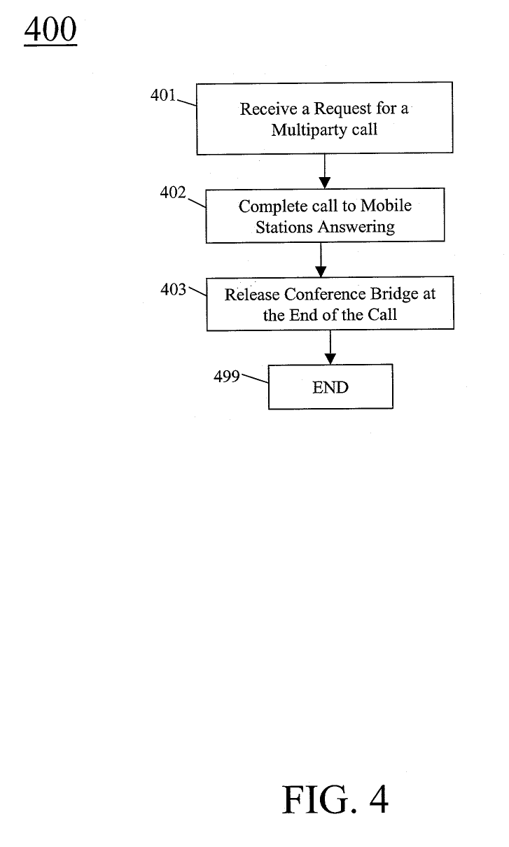

Network call control function 143 requests (207) the network conference bridge 149 to setup a multiparty call to the mobile stations in the wireless extension group that are in the geographic location. The processing that occurs in the network bridging function is depicted in FIG. 4 below. The process then ends (299).

Turning to FIG. 4, FIG. 4 depicts a flowchart 400 of a method for processing in network conference bridging function 149 the call request in accordance with an exemplary embodiment of the present invention. Network conference bridging function 149 receives (401) a multiparty call request.

Network bridging function completes (402) the multiparty call to all specified mobiles answering the multiparty call. This is accomplished by alerting the mobile stations specified in the multiparty call request and waiting a predetermined time for those mobile stations to respond to the alerting. Mobile stations not responding are not bridged onto the call. If no mobile stations respond, normal call processing occurs between the calling phone and the called mobile station.

Bridging then occurs between the calling phone, the called mobile station, and all extension group members that have responded affirmatively to the call request. When the multiparty call has ended, network conference bridging function 149 releases (403) the conference bridge. The process then ends (499).

The present invention thereby provides a method for providing extension capabilities to wireless mobile stations. By using the present invention, a user can be given the same functionality as is available with wireline extension phones. Prior art does not support this functionality for mobile phones. When coupled with the ability of determining the geographical location of other mobile stations, multiple benefits are recognized. These include employee group members located at a corporate campus being alerted to an incoming call; family members located at or near the residence being alerted to an incoming call; or no geographical limitation being imposed on the alerting all extension group members. Individual extension list members can decide not to join the extension call and continue to use the mobile station in an independent manner.

While this invention has been described in terms of certain examples thereof, it is not intended that it be limited to the above description, but rather only to the extent set forth in the claims that follow.

We claim:

1. A method of providing extension service in a wireless communication system, the method comprising the steps of:
receiving at a network call control function an incoming call request from a calling phone for a mobile station;
determining that the mobile station is capable of wireless extension service;
determining a list of wireless extension members associated with the mobile station; and
requesting a network conference bridge to initiate a multiparty call between the calling phone, the mobile station, and the wireless extension members.

2. A method of providing wireless extension service in accordance with claim 1, further comprising the step of determining if location determination for the wireless extension service of the mobile station is enabled.

3. A method of providing wireless extension service in accordance with claim 2, further comprising the step of determining the location of the wireless extension members.

4. A method of providing wireless extension service in accordance with claim 3, wherein the step of requesting a network conference bridge to initiate a multiparty call comprises the step of requesting the network conference bridge to initiate a multiparty call to wireless extension members located within a predetermined geographical location.

5. A method of providing wireless extension service in accordance with claim 1, wherein the step of determining that the mobile station is capable of wireless extension service comprises the steps of:
querying a user profile data base requesting call completion instructions; and
accepting instructions from the user profile data base as to the completion of the call.

6. A method of providing wireless extension service in a wireless communication system, the method comprising the steps of:
receiving a request for a wireless extension multiparty call at a network conference bridge, the wireless extension multiparty call including a calling phone, a called mobile station, and at least one wireless extension member; and
initiating the wireless extension multiparty call between the calling phone, the called mobile station, and the at least one wireless extension member.

7. A method of providing extension functionality in accordance with claim 6, wherein the step of initiating the wireless extension multiparty call comprises completing the multiparty call to those mobile stations included in the list which accept the multiparty call.

8. A method of providing extension functionality in accordance with claim 6, wherein the step of initiating the wireless extension multiparty call comprises completing the multiparty call to those mobile stations included in the list which accept the multiparty call within a predetermined time.

9. A method of providing extension functionality in accordance with claim 6, wherein the step of initiating a multiparty call comprises releasing the network conference bridge at the end of the multiparty call.

10. An apparatus for providing extension service in a wireless communication system, the apparatus comprising:
means for receiving at a network call control function an incoming call request from a calling phone for a mobile station;
means for determining that the mobile station is capable of wireless extension service;
means for determining a list of wireless extension members associated with the mobile station; and
means for requesting a network conference bridge to initiate a multiparty call between the calling phone, the mobile station, and the wireless extension members.

11. An apparatus in accordance with claim 10, the apparatus further comprising means for determining if location determination for the wireless extension service of the mobile station is enabled.

12. An apparatus in accordance with claim 11, the apparatus further comprising means for determining the location of the wireless extension members.

13. An apparatus in accordance with claim 12, wherein the means for requesting a network conference bridge to initiate a multiparty call comprises means for requesting the network conference bridge to initiate a multiparty call to wireless extension members located within a predetermined geographical location.

14. An apparatus in accordance with claim 10, wherein the means for determining that the mobile station is capable of wireless extension service comprises:
means for querying a user profile data base requesting call completion instructions; and
means for accepting instructions from the user profile data base as to the completion of the call.

15. An apparatus for providing wireless extension service in a wireless communication system, the apparatus comprising:
means for receiving a request for a wireless extension multiparty call at a network conference bridge, the wireless extension multiparty call including a calling phone, a called mobile station, and at least one wireless extension member; and
means for initiating the wireless extension multiparty call between the calling phone, the called mobile station, and the at least one wireless extension member.

16. An apparatus in accordance with claim 15, wherein the means for initiating the wireless extension multiparty call comprises completing the multiparty call to those mobile stations included in the list which accept the multiparty call.

17. An apparatus in accordance with claim 15, wherein the means for initiating the wireless extension multiparty call comprises completing the multiparty call to those mobile stations included in the list which accept the multiparty call within a predetermined time.

18. An apparatus in accordance with claim 15, wherein the means for initiating a multiparty call comprises releasing the network conference bridge at the end of the multiparty call.
